(19) United States
(12) Patent Application Publication
(10) Pub. No.: US 2024/0386425 A1
(43) Pub. Date: Nov. 21, 2024

(54) REVOKING IN-FLY AUDITED TRANSACTIONS

(71) Applicant: International Business Machines Corporation, Armonk, NY (US)

(72) Inventors: Angelo De Caro, Zurich (CH); Kaoutar El Khiyaoui, Zurich (CH); Arne Rutjes, Groningen (NL)

(21) Appl. No.: 18/319,733

(22) Filed: May 18, 2023

(51) Int. Cl. G06Q 20/40; G06Q 20/38

(52) U.S. Cl. CPC G06Q 20/401; G06Q 20/389

(57) ABSTRACT

A method for safeguarding an in-flight audited transaction in a distributed ledger system is disclosed. The method comprises creating a transfer transaction for an asset by a transaction sender, wherein the transfer transaction is in a pending status, adding an auditor signature to the transfer transaction, and storing the audited transfer transaction in the pending status in an auditor database. Additionally, the method comprises: upon submitting the transfer transaction in the pending status by the transaction sender, marking the transfer transaction as valid or invalid in the auditor database.

### BACKGROUND

The invention relates generally to a method for safeguarding a transaction, and more specifically, to a method for safeguarding an in-flight audited transaction in a distributed ledger system.

The importance of digital currencies has grown steadily over the past decade. More recently, the importance of cash seems to be declining. People in some countries have been using it a lot less recently—especially, during the COVID-19 pandemic, with its cash shortages and hygiene concerns. At the same time, various of recent digital disruptions—including the emergence of crypto-currencies and blockchain technologies—have made waves in the financial-service sector. Of course, digital currencies are part of that trend, and both, central banks as well as regulators have started to take notice. Bitcoin and Eutherium mark only the tip of the iceberg of digital currencies based on blockchain technology.

Now, in order to increase trust and stability of blockchain based asset transactions, an active auditing may be required for the transactions. For example, each transaction has to be validated before it gets committed to the ledger system. Indeed—in such a scenario—if the transaction is not signed by the auditor, the transaction gets rejected. Furthermore, an active auditor has to keep track of all transactions audited so far in what is denoted as the audit database. This can be used to enforce limits on the capability of parties to spend the funds.

### SUMMARY OF THE INVENTION

Aspects of the present invention disclose a computer-implemented method, a computer system and computer program product for safeguarding an in-flight audited transaction in a distributed ledger system. The computer implemented method may be implemented by one or more computer processors and may include: creating a transfer transaction for an asset by a transaction sender, wherein said transfer transaction is in a pending status; adding an auditor signature to said transfer transaction; storing said audited transfer transaction in said pending status in an auditor database; upon submitting said transfer transaction in said pending status by said transaction sender; and marking said transfer transaction as one of valid and invalid in said auditor database.

According to another embodiment of the present invention, there is provided a computer system. The computer system comprises a processing unit; and a memory coupled to the processing unit and storing instructions thereon. The instructions, when executed by the processing unit, perform acts of the method according to the embodiment of the present invention.

According to a yet further embodiment of the present invention, there is provided a computer program product being tangibly stored on a non-transient machine-readable medium and comprising machine-executable instructions. The instructions, when executed on a device, cause the device to perform acts of the method according to the embodiment of the present invention.

### BRIEF DESCRIPTION OF THE DRAWINGS

Preferred embodiments of the invention will be described, by way of example only, and with reference to the following drawings:

FIG. 1 shows a block diagram of an embodiment of the inventive method for safeguarding an in-flight audited transaction in a distributed ledger system;

FIG. 2 shows a block diagram of a digital asset transformation using active auditing;

FIG. 3 shows a block diagram of the general concept of the UTXO model;

FIG. 4 shows as a block diagram a transaction validation in the used UTXO environment;

FIG. 5 shows a block diagram of the proposed transaction validation using a pool of transactions;

FIG. 6 shows a block diagram of revoking a transaction;

FIG. 7 shows a block diagram of an embodiment of the inventive audited transaction safeguarding system for safeguarding an in-flight audited transaction in a distributed ledger system; and

FIG. 8 shows an embodiment of a computing system comprising the system according to FIG. 7.

### DETAILED DESCRIPTION

In the current field, as it relates to transactions of digital currency, blockchain technology has been leveraged for auditing those digital transactions. Now, in order to increase trust and stability of blockchain based asset transactions, an active auditing may be required for the transactions. For example, each transaction has to be validated before it gets committed to the ledger system. Indeed—in such a scenario—if the transaction is not signed by the auditor, the transaction gets rejected. However, the question is: What if a user, Bob, generates a transaction that gets audited but then Bob does not submit it? The simple answer is that the auditor would keep forever this pending transaction in his audit database. The auditor may then decide to delete this not submitted transaction after a period of time. If then Bob then would submits the transaction after the auditor has marked the transaction as deleted, the transaction would still be committed, confusing the auditor database and additionally all the checks/authorizations the auditor has previously performed. Hence there may be a need to avoid the situation in order to guarantee an error-free and consistent way to operate an active auditing process of digital asset transactions.

In the context of digital assets, a number of solutions have been proposed to solve this scenario. One such solution describes systems that may use the issuance and management of digital certificates and a revocation database to limit and monitor participation of parties to conduct transactions in a distributed network system. A compliance server system may validate entities and issue security certificates to entities to conduct transactions on a distributed network system. Another solution discloses a complete protocol for revocation and auditability for permission in blockchain systems using anonymous credential schemes.

However, none of the known solutions seems to be able to solve the above presented problem of deletions in the auditor database. Thus, there is still a need for a solution.

Embodiments of the present invention recognizes the deficiencies in the current field as it relates deletion of auditor database associated with a pending blockchain transaction and proposes a novel approach/solution. One approach involves creating a transfer transaction for an asset by a transaction sender, where the transfer transaction is in a pending status, adding an auditor signature to the transfer transaction, and storing the audited transfer transaction in the pending status in an auditor database. There are many approaches of the present invention, some may be found under “OTHER EMBODIMENTS AND COMMENTS”.

It should be noted that embodiments of the invention are described with reference to different subject-matters. In particular, some embodiments are described with reference to method type claims, whereas other embodiments are described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered as to be disclosed within this document.

The aspects defined above and further aspects of the present invention are apparent from the examples of embodiments to be described hereinafter and are explained with reference to the examples of embodiments to which the invention is not limited.

### Terminology

In the context of this description, the following technical conventions, terms and/or expressions may be used:

The term ‘distributed ledger system’ (DLT) may denote a digital system for recording transactions of assets in which the transactions and the details are recorded in multiple places, using distributed nodes, at the same time. Unlike traditional central databases, distributed ledgers have no central data store or administration functionality. Instead, a peer-to-peer consistency check may ensure that all nodes may record the same transactions in the same way. Typical implementations use blockchain technology, like Bitcoin, Eutherium or Hyperledger Fabric.

The term ‘asset’ may denote here a monetary value codified as one or more digital tokens.

The term ‘transfer transaction’ may denote a handover of assets in an electronic way from one owner to another one.

The term ‘transaction sender’ may denote an initiator of a transaction in order to start an asset transfer from the initiator or sender to a receiver using a distributed ledger system.

The term ‘auditor database’ may denote a database—or a file system mechanism—of transactions related to the auditor authority for active auditing for transactions using a distributed ledger system. It should be noted that the auditor database is not to be intermixed with the underline ledger system.

The term ‘auditor signature’ may denote an added digital code to a transaction, where the additional digital code originates from the auditor.

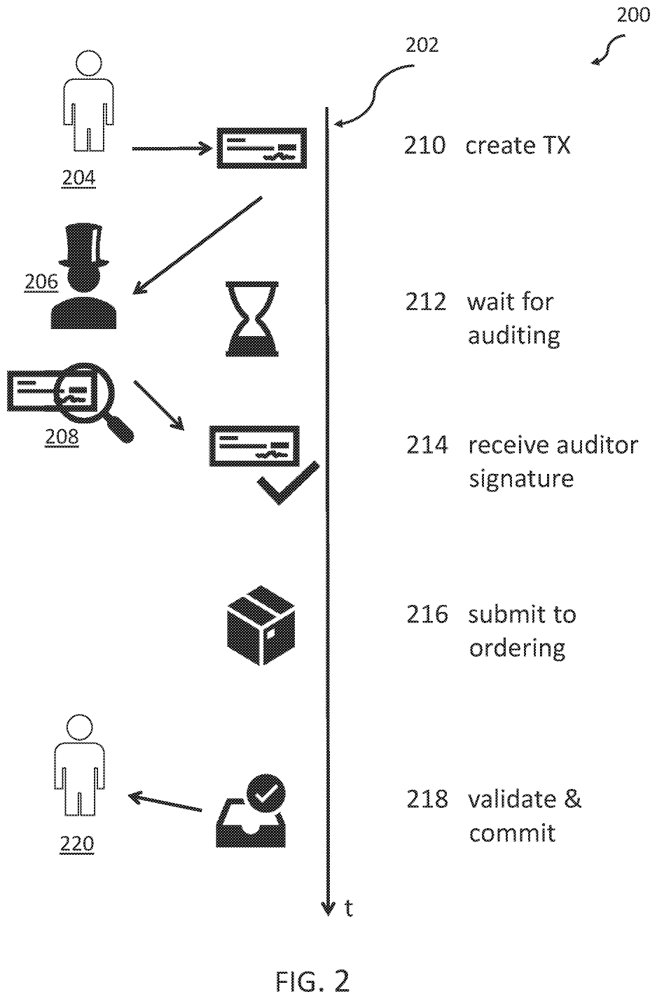

The term ‘in-flight audited transaction’ may denote a transaction which may not yet have been committed to the ledger system. The transaction has been created—in particular, by the originator or sender—may or may not have been confirmed by the auditor but which may not have yet been finally submitted in order to finally commit the transaction. Another expression for a transaction in such a status may be a ‘transaction in a pending status’ (compare FIG. 2).

The term ‘submitting the transfer transaction’ may denote the activity of triggering a commitment of a transaction after the transaction may have been validated by the auditor (compare FIG. 2).

The term ‘smart contract’ may denote comparable simple programs stored in a blockchain which may be executed if a predefined condition is fulfilled. Typically, they may be used to automate a legally binding conclusion of a contract. They way, all constituents may be sure about the result without requiring an intermediary and time may be saved. Hence, workflows may be automated and actions may be triggered if the predefined condition is fulfilled. In some blockchain implementations, the program code related to the smart contract may also be denoted as chaincode, e.g., in Hyperledger Fabric.

### Description of Figures

In the following, a detailed description of the figures will be given. All instructions in the figures are schematic. Firstly, a block diagram of an embodiment of the inventive method for safeguarding an in-flight audited transaction in a distributed ledger system is given. Afterwards, further embodiments, as well as embodiments of the audited transaction safeguarding system for safeguarding an in-flight audited transaction in a distributed ledger system will be described.

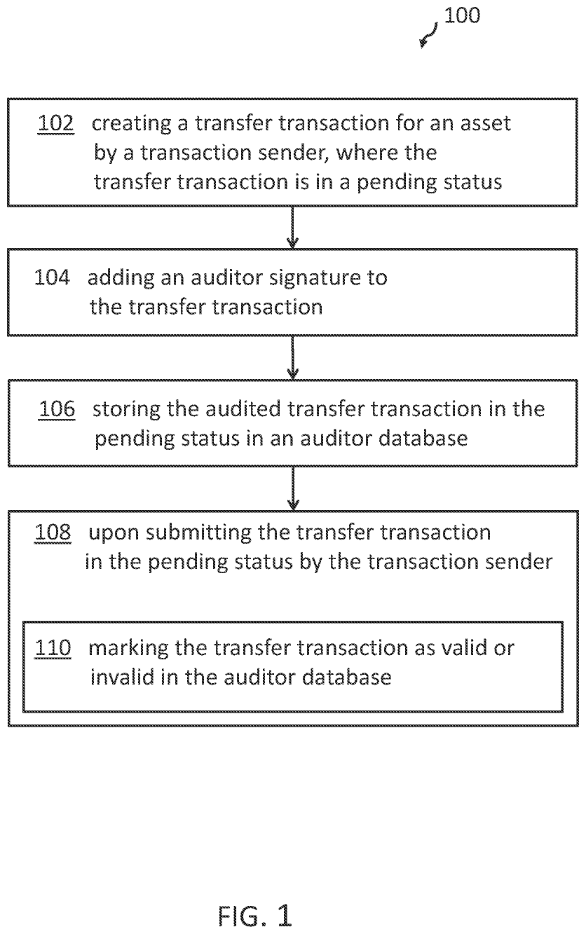

FIG. 1 shows a block diagram of a preferred embodiment of the method 100 for safeguarding an in-flight audited transaction in a distributed ledger system. Examples of the distributed ledger system may be a Bitcoin, Eutherium, Hyperledger Fabric and others. The method comprises creating, 102, a transfer transaction for an asset by a transaction sender, where the transfer transaction is in a pending status, adding, 104, an auditor signature to the transfer transaction, and storing, 106, the audited transfer transaction in the pending status in an auditor database. Hence, the proposed concept addresses the context of an active auditing of crypto currency asset transactions.

Furthermore, upon submitting, 108, the transfer transaction in the pending status by the transaction sender, the method 100 comprises marking, 110, the transfer transaction as one of valid and invalid in the auditor database. Hence, the sender submits the transaction to the distributed ledger system, then the distributed ledger system notifies the auditor about the validity of the transaction. The auditor can then mark the transaction as VALID or INVALID.

FIG. 2 shows a block diagram of a digital asset transformation 200 using active auditing. In this case, Bob (artificial name) 204 wants to transfer digital assets to Alice (artificial name) 220 in an environment with active auditing. Firstly, Bob creates—or better, his client system—creates, 210, the transaction TX as the initial step of the timeline 202. As a first subsequent step, the auditor 206 has to validate, 208, the signature of Bob and add or receive, 214, the auditor's signature. Hence, along the timeline, this is shown as “wait for auditing, 212”. After the auditor signature was received, Bob 204 can submit, 216 the transaction to the order, where everything is validated and committed, 218, in the ledger system so that Alice 220 eventually receives the funds in form of a crypto-currency amount. As can be seen, the auditing process delays the sequence of steps along the timeline 202. Furthermore—as described already before—problems may occur if Bob 204 would never submit the order (i.e., the submitting) and/or the auditor would delete the original transaction TX 210 in his auditor database. This marks the environment in which the newly proposed solution must operate.

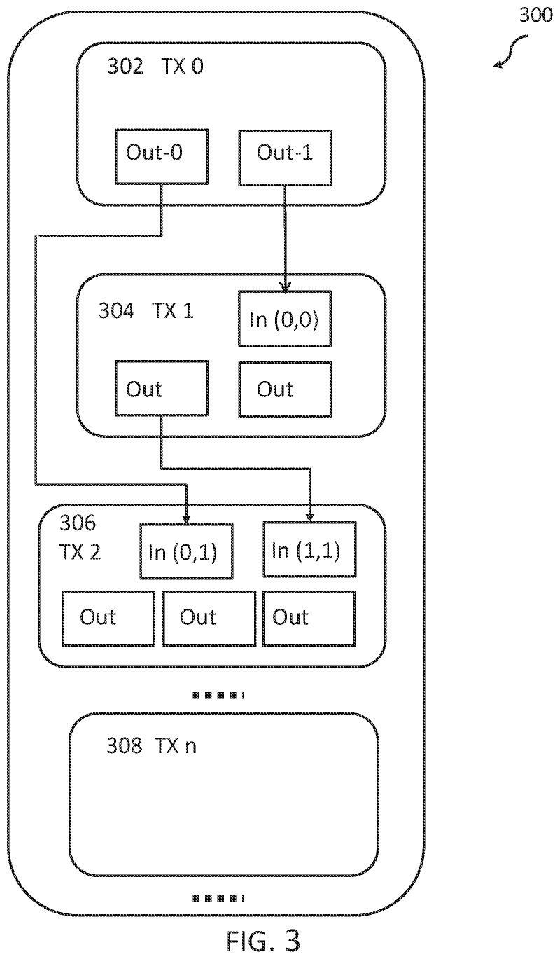

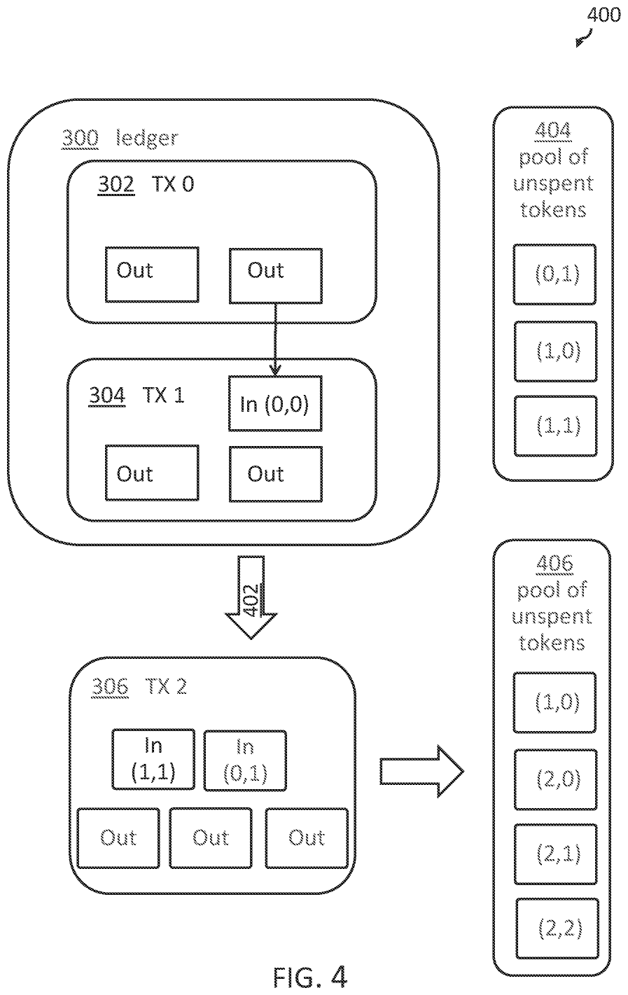

FIG. 3 shows a block diagram of the general concept of the UTXO model 300. Also, this diagram shows the technical environment in which the proposed solution needs to work. This is also true for FIG. 4. However, it helps to increase the comprehension of the newly proposed concept.

With the help of FIG. 3, the UTXO model can be explained easily. All transactions TX 0/302, TX 1/304, TX 2/306, . . . , TX n/308 are finally managed within the ledger system 300. Each transaction comprises a plurality (which can also be “1”) of inputs and outputs, like Out, Out of TX 0/302. Outputs can be described in the form of <v, pk>, where v is the value this output comprises and pk is the public key of the owner or originator of the transaction.

Inputs of transactions are represented in the form of <TXid, oidx>, where TXid is a unique transaction identifier and oidx is the output index. As will be seen in the next figure, token transactions are consolidated in a pool of unspent tokens. Furthermore, a token transaction removes the inputs from the pool and adds the outputs to the pool of unspent tokens.

Furthermore, the auditor is responsible to verify the validity of the fund transfer, e.g., that transactions are within certain, predefined limits. Finally, users can use received funds, only if previous trends actions are valid, i.e., validated through the auditor.

Reflecting all of this, one can easily see that transaction TX 2/306 has two inputs—in particular, In (0,1) and In (1,1)—and three outputs, and so on.

FIG. 4 shows as a block diagram a transaction validation process 400 in the used UTXO environment. Here, the underlying ledger system 300 comprises—as an example—only the two transactions TX 0/302 and Tx 1/304. Now, the transaction TX 2/306 is appended, 402. The related validation predicate ensures that the transaction is valid and the required double-spending check ensures that inputs should still be in the pool of unspent tokens. These are shown as the pool of unspent tokens 404 before appending, 402, the transaction TX 2, and the pool of unspent transactions 406 after appending, 402, the transaction TX 2. As can be recognized easily, the first index of the pull of unspent token 406 after pending, 204, transaction TX 2 is a “2” in compliance with the above explanation regarding TXid which is a unique transaction identifier.

The pool of unspent tokens—after each transaction—should be available on each node of the distributed ledger system and may also be derived by the ledger system. Elements of the pool of unspent tokens are not part of the blockchain of the ledger system. What can also be seen is that after a transaction, inputs are removed from the pool of unspent transactions. This is why the elements In (0,1) and In (1,1) are no longer part of the pool of unspent tokens 406, but In (1,0) remains. As a reminder, up to here, the existing UTXO model has been described in which the newly proposed concept should be integrated.

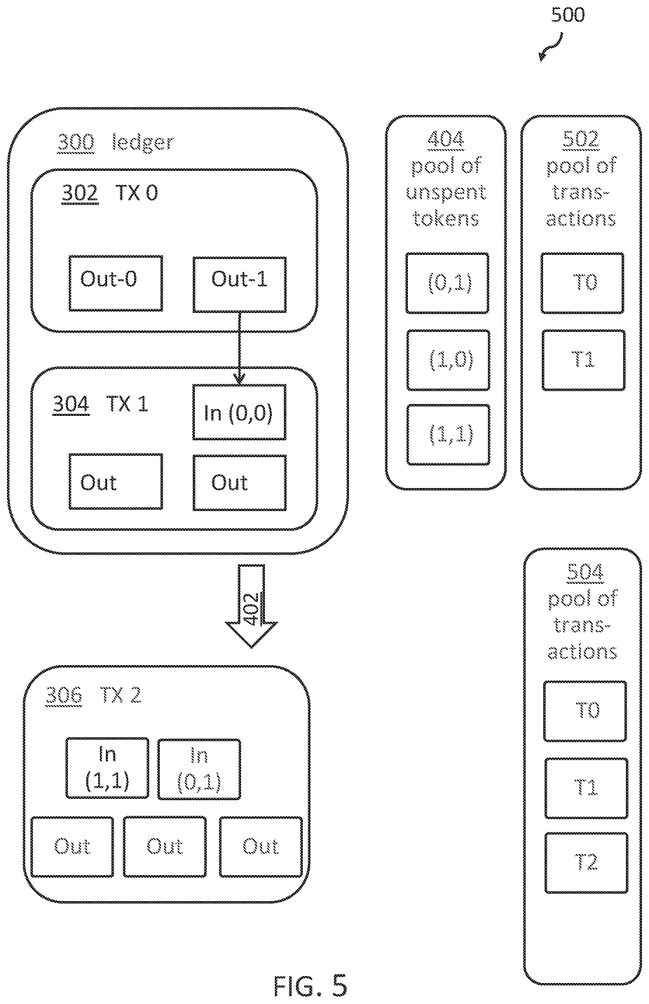

FIG. 5 shows a block diagram of the newly proposed transaction validation process 500 using a pool of transactions. Basically, the ledger system 300 as well as appending the transaction TX 2/306 as well as the pool of unspent tokens 404 is identical to what has been explained in the context of FIG. 4. However, the new transaction validation—which is newly proposed here—requires an additional check, namely the revoked transaction check. For this, the pool of transactions 502 before appending the transaction TX 2 and after the integration of the transaction TX 2 into the ledger system 300 is instrumental. The three required checks are now (i) the validation predicate which ensures that the transaction is valid, (ii) the double-spending check according to which inputs should be still available in the pool of unspent tokens which requires only a simple search, and (iii) the revoked transaction check according to which the transaction should not be in the pool of transactions 502, 504 respectively. In the colons to the pool of unspent tokens, also the pull of transactions could be derived from the ledger system 300.

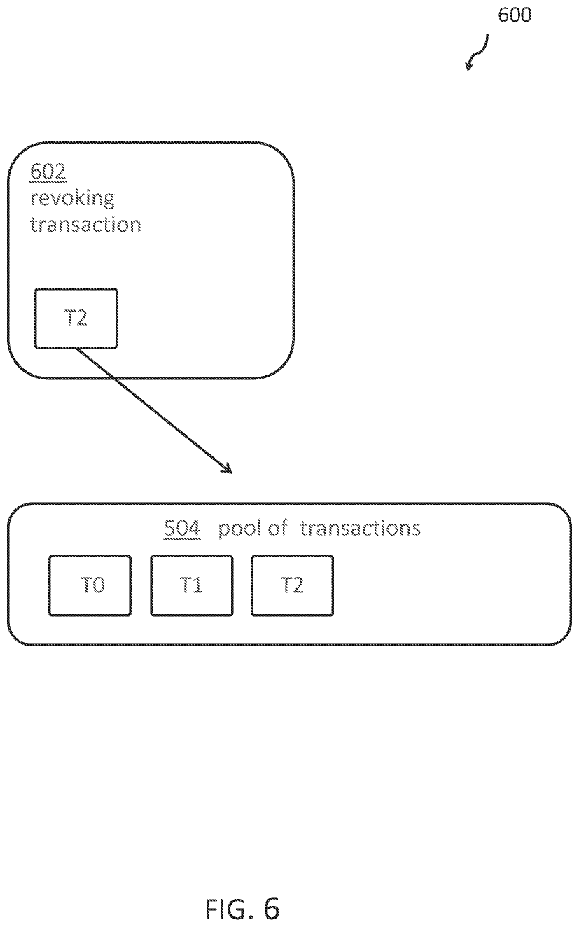

FIG. 6 shows a block diagram of revoking a transaction 600. It should be noted that the auditor is the only entity that can submit a “revoking” transaction. Furthermore, the “revoking” transaction 602 appends the passed identifier to the pool of transactions 504. Hence, the transaction TX 2 would now be part of the pool of transactions 504. Because as part of the three-part check (see above) the transaction to be appended should not be in the pool of transactions 504—in this case—appending the transaction would fail.

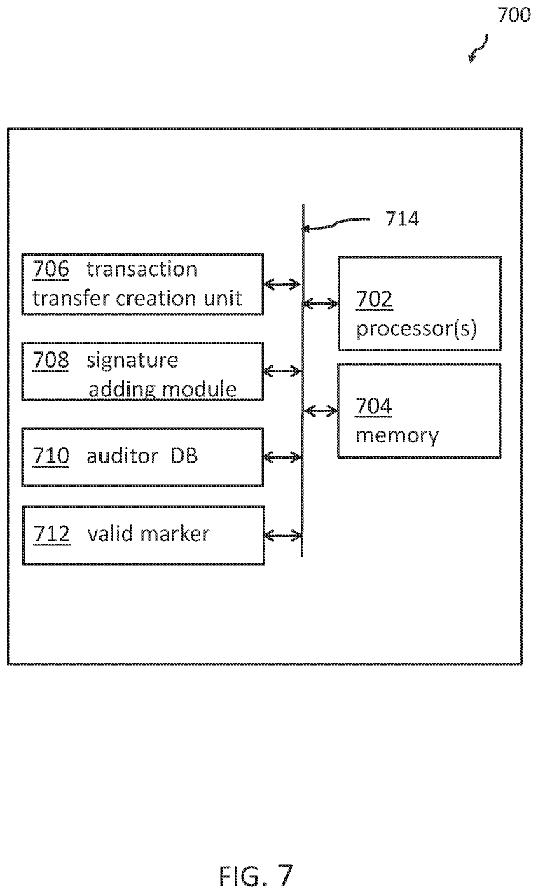

FIG. 7 shows a block diagram of an embodiment of the audited transaction safeguarding system 700 for safeguarding an in-flight audited transaction in a distributed ledger system. The system comprises one or more processors 702 and a memory 704 operatively coupled to the one or more processors 702, wherein the memory 704 stores program code portions which, when executed by the one or more processors 702, enable the one or more processors 702 to create—in particular, by a transaction transfer creation unit 706—a transfer transaction for an asset by a transaction sender, where the transfer transaction is in a pending status, to add an auditor signature to the transfer transaction—in particular, by a signature adding module 708—and to store the audited transfer transaction in the pending status in an auditor database 710.

Furthermore, the one or more processors 702 are—upon submitting the transfer transaction in the pending status by the transaction sender—to mark the transfer transaction as valid or invalid in the auditor database by a valid marker 712.

It shall also be mentioned that all functional units, modules and functional blocks—in particular, the one or more processors 702, the memory 704, the transaction transfer creation unit 706, the signature adding module 708, the auditor database 710 and the valid marker 712—may be communicatively coupled to each other for signal or message exchange in a selected 1:1 manner. Alternatively the functional units, modules and functional blocks can be linked to a system internal bus system 714 for a selective signal or message exchange.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (CPP embodiment or CPP) is a term used in the present disclosure to describe any set of one, or more, storage media (also called mediums) collectively included in a set of one, or more, storage devices that collectively include machine readable code corresponding to instructions and/or data for performing computer operations specified in a given CPP claim. A storage device is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

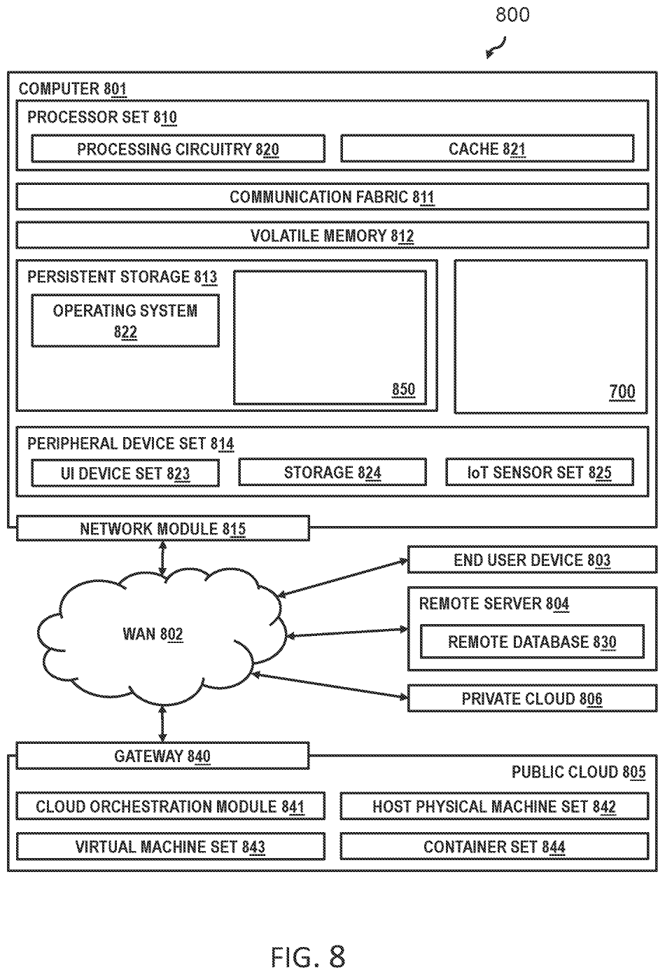

FIG. 8 shows a computing environment 800 comprising an example of an environment for the execution of at least some of the computer code involved in performing the inventive methods, such as the method for safeguarding an in-flight audited transaction in a distributed ledger system 850.

In addition to block 850, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 850, as identified above), peripheral device set 814 (including user interface (UI), device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 850 in persistent storage 813.

COMMUNICATION FABRIC 811 is the signal conduction paths that allow the various components of computer 801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, the volatile memory is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface type operating systems that employ a kernel. The code included in block 850 typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (e.g., embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

It should also be mentioned that the audited transaction safeguarding system for safeguarding an in-flight audited transaction in a distributed ledger system (compare FIG. 7) can be an operational sub-system of the computer 801 and may be attached to a computer-internal bus system.

The terminology used herein is for the purpose of describing particular embodiments only and is not intended to limit the invention. As used herein, the singular forms a, an and the are intended to include the plural forms as well, unless the context clearly indicates otherwise. It will further be understood that the terms comprises and/or comprising, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present invention has been presented for purposes of illustration and description but is not intended to be exhaustive or limited to the invention in the form disclosed. Many modifications and variations will be apparent to those of ordinary skills in the art without departing from the scope and spirit of the invention. The embodiments are chosen and described in order to best explain the principles of the invention and the practical application, and to enable others of ordinary skills in the art to understand the invention for various embodiments with various modifications, as are suited to the particular use contemplated.

### Other Embodiments and Comments

According to one aspect of the present invention, a method for safeguarding an in-flight audited transaction in a distributed ledger system may be provided. The method may comprise creating a transfer transaction for an asset by a transaction sender, where the transfer transaction is in a pending status, adding an auditor signature to the transfer transaction, and storing the audited transfer transaction in the pending status in an auditor database.

Additionally, the method may comprise upon submitting the transfer transaction in the pending status by the transaction sender, marking the transfer transaction as one of valid and invalid in the auditor database.

According to another aspect of the present invention, an audited transaction safeguarding system for safeguarding an in-flight audited transaction in a distributed ledger system may be provided. The system may comprise one or more processors and a memory operatively coupled to the one or more processors, wherein the memory stores program code portions which, when executed by the one or more processors, enable the one or more processors to create a transfer transaction for an asset by a transaction sender, wherein the transfer transaction is in a pending status, to add an auditor signature to the transfer transaction, to store the audited transfer transaction in the pending status in an auditor database, and—upon submitting the transfer transaction in the pending status by the transaction sender—to mark the transfer transaction as one of valid and invalid in the auditor database.

The proposed method for safeguarding an in-flight audited transaction in a distributed ledger system may offer multiple advantages, technical effects, contributions and/or improvements:

Firstly, it may be possible to use the proposed concept without a need to fundamentally restructure existing blockchain systems for asset transactions. It may also be useful that the used ledger systems (i.e., based on the blockchain technology) do support a smart contract.

As described here, the proposed concept is also operable in the UTXO model, i.e., in the context of the concept of unspent transaction output, i.e., UTXO. This may be advantageous because many crypto-currencies use the UTXO model and not the pure account-based model based on all balances. Instead, individual coins (UTXOs) are transferred between users, much like physical coins or cash.

However, in the case of a valid blockchain transaction, unspent outputs (and only unspent outputs) of transactions may be used to fund other transactions. The requirement is that only unspent outputs may be used in further transactions as necessary to prevent double spending and fraud.

Advantageously, the proposed concept may be fully functioning in such environments of unspent tokens with active auditing. Thus, submitting a pending transaction, i.e. one that has been initiated, audited and not yet submitted, may lead to marking the pending transaction (or the transaction in the pending status) if this transaction gets finally submitted and consequently also valid or invalid in the ledger system. Hence, the status of the transactions in an active auditing setting can be retraced at any time. No deletion processes may be required in the auditor database if transactions that have started are not finally transmitted.

All in all, the proposed concept may allow to keep the auditor database consistent and clean without any artefacts of former, finally not closed transactions, e.g., created and not submitted, by means of the revoking transaction.

In the following, additional embodiments of the inventive concept—applicable for the method as well as for the system—will be described.

According to an advantageous embodiment, the method may also comprise: upon not submitting the transfer transaction in the pending status by the transaction sender, submitting to the distributed ledger system a revoking transaction linked to the transfer transaction in the pending status. This may be seen as a timeout mechanism. It may also be independent of the reason for not submitting the revoking transaction. However, a time delay may be reflected in the sense that the revoking transaction should be executed within a predefined time period after the related underlying original transaction, i.e., the transfer transaction and the pending status.

According to another advantageous embodiment, the method may also comprise: upon attempting to submit the transfer transaction in the pending status and upon determining a revoking transaction—in particular, initiated by the auditor—linked to the transfer transaction in the pending status, invalidating—i.e., revoking—the transfer transaction in the pending status. This may be seen as a natural addition to the embodiment described in the previous paragraph. Latest at this point, the receiver of the transfer transaction cannot spend the potentially received, related amount anymore. This is because the underlying ledger system would detect an unresolvable conflict. Hence, double spending is impossible.

According to an interesting embodiment, the method may also comprise maintaining a pool of invalidated transactions outside—or in parallel—the distributed ledger system. These may be those transactions which have been invalidated, as described in the previous paragraph.

According to another permissive embodiment, the method may also comprise maintaining a pool of unspent tokens—i.e., UTXO—outside (or in parallel) the distributed ledger system. This pool may be available on each node of the ledger system but outside the ledger system it may be maintained in form of entries in a file system and hence, outside the blockchain with which the digital currency, and accordingly also the digital tokens representing a monetary value, may be managed.

According to a further advantageous embodiment of the method, a transaction validation in the ledger system may comprise (i) determining that the transaction is not invalid, (ii) executing a double-spending check—i.e., the related tokens still need to be in the pool of unspent tokens—and (iii) determining that the transaction is not invalidated, i.e., it should not be in the pool of invalidated transactions. While the first two activities may already be available in existing ledger systems, the step (iii) may be pretty useful in the context of the concept proposed here. Only if all of the named checks are done, the transaction may be executed in the ledger. It may also be noted that (i) and (iii) should not be intermixed; the transaction can be invalid for many reasons including wrongly used keys etc.; however, (iii) may relate to the transaction of the auditor marking the transaction actively as invalid.

According to another useful embodiment, the method may also comprise performing active auditing by validating each transaction before it gets committed in the distributed ledger system. Hence, the probability of a corrupted blockchain of the distributed ledger system may be reduced significantly or may be made impossible.

According to an enhanced embodiment of the method, a transaction validation may be performed by a smart contract which uses a transaction identifier TxID as a unique key kTxID bound to the transaction initiator or transaction sender. This way, it may be possible that existing ledger systems—one example being Hyperledger Fabric—may be used unchanged together with the newly proposed concept. This is possible because the transaction validation may be performed by a smart contract—or chaincode—which may use the TxID as a unique key kTxID. Thereby, the TxID (transaction ID) is supposed to be unique and bound to the creator of the transaction. The smart contract/chaincode may read kTxID; and if the value is already found, then the chaincode fails. Otherwise, the read dependency is added to the RWset (read/write set).

In this context, it may be understood that in the context of, e.g., Hyperledger Fabric the read/write set may refer to the set of key-value pairs that have been read or modified during the execution of the transaction. For example, when a client may submit a transaction to the network, it is processed by a set of endorsing peers (i.e., nodes of the distributed ledger system), which execute the transaction and create a read/write set containing the keys that have been read or written during the execution. The read/write set that is then returned to the client, who sends it to the ordering service along with the transaction proposal. Thereby, an ordering service uses the read/write set to ensure that the transactions are executed in a deterministic order which is necessary for achieving consensus among the natural participants.

Furthermore, the read/write set may also help to ensure that the state changes made by the transactions may be consistent across the network of connected nodes, by allowing each validating pair to verify that the transaction is valid and that the resulting state changes are consistent with the roots of the underlying smart contract.

According to an additionally interesting embodiment, the method may also comprise: upon determining for a transaction at committing time that a multi-version concurrency control (MVCC) is enforcing a read-dependency unique key kTxID, committing the transaction, or not committing the transaction. Hence, the transaction would fail.

In the context of a hypothetical system of the type Hyperledger Fabric, at commitment time, a transaction must parse what is called the MVCC check. These may be used to ensure that transactions do not overwrite each other's changes to the same data on the ledger. If the MVCC check may fail, the transaction may be deemed invalid. Exactly this mechanism may be leveraged here to invalidate an in-flight transaction as follows:

When the transaction TX may be executed, in the RWSet, the chaincode may add a read dependency to the key corresponding to the transaction ID. In order to invalidate this transaction, the auditor may submit another transaction whose RWSet may also comprise a write entry with a key matching the transactions TX id of the transaction the auditor may want to invalidate. This transaction may be denoted as TX_invalidate.

If TX_invalidate may be committed before the transaction TX, then the version of the key corresponding to the transaction ID is increased (e.g., by 1). Now, if the transaction TX may be processed, the MVCC may check if it had a different version then the latest version available, since TX_invalidate may have incremented the version of this key. Now, if TX_invalidate is processed after the transaction TX, and then TX_invalidate is marked as invalid. This is also fine since the auditor now knows about the validity of the original transaction TX.

Thus, and according to a further embodiment, the method may comprise invalidating the transaction by submitting an invalidation transaction by an auditor, where the invalidation transaction has a read-write set comprising a read entry with a key matching the transactions identifier equal to the committed transaction.

Furthermore, embodiments may take the form of a related computer program product, accessible from a computer-usable or computer-readable medium providing program code for use by or in connection with a computer or any instruction execution system by or in connection with a computer or any instruction execution system. For the purpose of this description, a computer-usable or computer-readable medium may be any apparatus that may contain means for storing, communicating, propagating or transporting the program for use by or in connection, with the instruction execution system, apparatus, or device.

In a nutshell, the inventive concept can be summarized by the following clauses:
1. A computer-implemented method for safeguarding an in-flight audited transaction in a distributed ledger system, the method comprising
   creating a transfer transaction for an asset by a transaction sender, wherein the transfer transaction is in a pending status,
   adding an auditor signature to the transfer transaction,
   storing the audited transfer transaction in the pending status in an auditor database,
   upon submitting the transfer transaction in the pending status by the transaction sender,
      marking the transfer transaction as one of valid and invalid in the auditor database.
2. The method according to clause 1, also comprising
   upon not submitting the transfer transaction in the pending status by the transaction sender,
      submitting to the distributed ledger system a revoking transaction linked to the transfer transaction in the pending status.
3. The method according to clause 2, also comprising
   upon attempting to submit the transfer transaction in the pending status and
      upon determining a revoking transaction linked to the transfer transaction in the pending status,
         invalidating the transfer transaction in the pending status.
4. The method according to any of the preceding clauses, also comprising
   maintaining a pool of invalidated transactions outside the distributed ledger system.
5. The method according to any of the preceding clauses, also comprising
   maintaining a pool of unspent tokens outside the distributed ledger system.
6. The method according to claim 1, wherein a transaction validation in the ledger system comprises
   determining that the transaction is not invalid,
   executing a double spending check, and
   determining that the transaction is not invalidated.
7. The method according to any of the preceding clauses, also comprising
   performing active auditing by validating each transaction before it gets committed in the distributed ledger system.
8. The method according to any of the preceding clauses, wherein
   a transaction validation if performed by a smart contract which uses a transaction identifier TxID as a unique key kTxID bound to the transaction initiator.
9. The method according to clause 8, also comprising
   upon determining for a transaction at committing time that a multi-version concurrency control is enforcing a read-dependency unique key kTxID,
      committing the transaction, or
      not committing the transaction.
10. An audited transaction safeguarding system for safeguarding an in-flight audited transaction in a distributed ledger system, the system comprising
   one or more processors and a memory operatively coupled to the one or more processors, wherein the memory stores program code portions which, when executed by the one or more processors, enable the one or more processors to
   create a transfer transaction for an asset by a transaction sender, wherein the transfer transaction is in a pending status,
   add an auditor signature to the transfer transaction,
   store the audited transfer transaction in the pending status in an auditor database,
   upon submitting the transfer transaction in the pending status by the transaction sender,
      mark the transfer transaction as one of valid and invalid in the auditor database.
11. The system according to clause 10, wherein the one or more processors are also enabled to:
   upon not submitting the transfer transaction in the pending status by the transaction sender,
      submitting to the distributed ledger system a revoking transaction linked to the transfer transaction in the pending status.
12. The system according to clause 11, wherein the one or more processors are also enabled to
   upon attempting to submit the transfer transaction in the pending status and
      upon determining a revoking transaction linked to the transfer transaction in the pending status,
         invalidate the transfer transaction in the pending status.
13. The system according to any of the clauses 10 to 12, wherein the one or more processors are also enabled to
   maintain a pool of invalidated transactions outside the distributed ledger system.
14. The system according to any of the clauses 10 to 13, wherein the one or more processors are also enabled to
   maintain a pool of unspent tokens outside the distributed ledger system.
15. The system according to any of the clauses 10 to 14, wherein during a transaction validation in the ledger system the one or more processors are also enabled to
   determining that the transaction is not invalid,
   executing a double spending check, and
   determining that the transaction is not invalidated.
16. The system according to any of the clauses 10 to 15, wherein the one or more processors are also enabled to
   perform active auditing by validating each transaction before it gets committed in the distributed ledger system.
17. The system according to any of the clauses 10 to 126, wherein the one or more processors is also enabled to
   perform a transaction validation by a smart contract which uses a transaction identifier TxID as a unique key kTxID bound to the transaction initiator.
18. The system according to any of the clauses 10 to 17, wherein the one or more processors are also enabled to:
   upon determining for a transaction at committing time that a multi-version concurrency control is enforcing a read-dependency unique key kTxID,
      commit the transaction, or
      not committing the transaction.
19. A computer program product for an unspent-transaction-output-(UTXO)-based privacy-preserving token system for enabling digital cash functionalities and privacy-preserving limit enforcement, the computer program product comprising a computer readable storage medium having program instructions embodied therewith, the program instructions being executable by one or more computing systems or controllers to cause the one or more computing systems to
   create a transfer transaction for an asset by a transaction sender, wherein the transfer transaction is in a pending status,
   add an auditor signature to the transfer transaction,
   store the audited transfer transaction in the pending status in an auditor database,
   upon submitting the transfer transaction in the pending status by the transaction sender,
      mark the transfer transaction as one of valid and invalid in the auditor database.

What is claimed is:

1. A method for safeguarding an in-flight audited transaction in a distributed ledger system, said method comprising:
creating a transfer transaction for an asset by a transaction sender, wherein said transfer transaction is in a pending status;
adding an auditor signature to said transfer transaction;
storing said audited transfer transaction in said pending status in an auditor database;
upon submitting said transfer transaction in said pending status by said transaction sender; and
marking said transfer transaction as one of valid and invalid in said auditor database.

2. The method according to claim 1, further comprising:
upon not submitting said transfer transaction in said pending status by said transaction Sender and submitting to said distributed ledger system a revoking transaction linked to said transfer transaction in said pending status.

3. The method according to claim 2, further comprising:
upon attempting to submit said transfer transaction in said pending status; and
upon determining a revoking transaction linked to said transfer transaction in said pending status, invalidating said transfer transaction in said pending status.

4. The method according to claim 1, further comprising:
maintaining a pool of invalidated transactions outside said distributed ledger system.

5. The method according to claim 1, further comprising:
maintaining a pool of unspent tokens outside said distributed ledger system.

6. The method according to claim 1, wherein a transaction validation in said ledger system further comprises:
determining that said transaction is not invalid;
executing a double spending check; and
determining that said transaction is not invalidated.

7. The method according to claim 1, further comprising:
performing active auditing by validating each transaction before it gets committed in said distributed ledger system.

8. The method according to claim 1, wherein a transaction validation if performed by a smart contract which uses a transaction identifier TxID as a unique key kTxID bound to said transaction initiator.

9. The method according to claim 8, further comprising:
upon determining for said transaction at committing time that a multi-version concurrency control is enforcing a read-dependency unique key kTxID; and
committing said transaction or not committing said transaction.

10. An audited transaction safeguarding system for safeguarding an in-flight audited transaction in a distributed ledger system, said system comprising:
one or more computer processors; and
one or more computer readable storage media having computer-readable program instructions stored on the one or more computer readable storage media, said program instructions executes, by the one or more computer processors, a computer-implemented method comprising the steps of:
creating a transfer transaction for an asset by a transaction sender, wherein said transfer transaction is in a pending status;
adding an auditor signature to said transfer transaction;
storing said audited transfer transaction in said pending status in an auditor database;
upon submitting said transfer transaction in said pending status by said transaction sender; and
marking said transfer transaction as one of valid and invalid in said auditor database.

11. The system according to claim 10, further comprising:
upon not submitting said transfer transaction in said pending status by said transaction Sender; and
submitting to said distributed ledger system a revoking transaction linked to said transfer transaction in said pending status.

12. The system according to claim 11, further comprising:
upon attempting to submit said transfer transaction in said pending status; and
upon determining a revoking transaction linked to said transfer transaction in said pending status, invalidating said transfer transaction in said pending status.

13. The system according to claim 10, further comprising:
maintaining a pool of invalidated transactions outside said distributed ledger system.

14. The system according to claim 10, further comprising:
maintaining a pool of unspent tokens outside said distributed ledger system.

15. The system according to claim 10, wherein during a transaction validation in said ledger system, further comprises:
determining that said transaction is not invalid;
executing a double spending check; and
determining that said transaction is not invalidated.

16. The system according to claim 10, further comprising:
performing active auditing by validating each transaction before it gets committed in said distributed ledger system.

17. The system according to claim 10, further comprising:
performing a transaction validation by a smart contract which uses a transaction identifier TxID as a unique key kTxID bound to said transaction initiator.

18. The system according to claim 17, further comprising:
upon determining for a transaction at committing time that a multi-version concurrency control is enforcing a read-dependency unique key kTxID; and
committing said transaction or not committing said transaction.

19. A computer program product for an unspent-transaction-output-(UTXO)-based privacy-preserving token system for enabling digital cash functionalities and privacy-preserving limit enforcement, said computer program product comprising a computer readable storage medium having program instructions embodied therewith, said program instructions being executable by one or more computing systems or controllers to cause said one or more computing systems to:
creating a transfer transaction for an asset by a transaction sender, wherein said transfer transaction is in a pending status;
adding an auditor signature to said transfer transaction;
storing said audited transfer transaction in said pending status in an auditor database;
upon submitting said transfer transaction in said pending status by said transaction sender; and
marking said transfer transaction as one of valid and invalid in said auditor database.

20. The computer program product of claim 19, further comprising:
upon not submitting said transfer transaction in said pending status by said transaction Sender and submitting to said distributed ledger system a revoking transaction linked to said transfer transaction in said pending status;
upon attempting to submit said transfer transaction in said pending status and upon determining a revoking transaction linked to said transfer transaction in said pending status, invalidating said transfer transaction in said pending status;
maintaining a pool of invalidated transactions outside said distributed ledger system; and
maintaining a pool of unspent tokens outside said distributed ledger system.
